(19) United States
(12) Patent Application Publication
(10) Pub. No.: US 2009/0148656 A1
(43) Pub. Date: Jun. 11, 2009

(54) Lamellar structure of food container

(75) Inventor: Hsin-Tarng Hsu, Taichung City (TW)

Correspondence Address: BACON & THOMAS, PLLC, 625 SLATERS LANE, FOURTH FLOOR, ALEXANDRIA, VA, 22314-1176, US

(73) Assignees: J&C PROSPERITY INT'L CO., LTD., Taichung City (TW); HSIN-TARNG HSU, Taichung City (TW)

(21) Appl. No.: 12/078,826

(22) Filed: Apr. 7, 2008

(30) Foreign Application Priority Data
Dec. 11, 2007 (TW) 96220989

(51) Int. Cl. B32B 5/12

(52) U.S. Cl. 428/113

(57) ABSTRACT

The present invention relates to a lamellar structure of food containers, which comprises a fiber layer and two biodegradable material layers adhering to two surfaces of the fiber layer, wherein the biodegradable material layer is formed by coating a biodegradable material precursor formula, which comprises a biodegradable polymer and a tenacity adjuster, wherein the tenacity adjuster includes a biological molecule and a biodegradable polymer precursor, water or mixtures thereof, and the tenacity adjuster is heat treated.

### BACKGROUND OF THE INVENTION

1. Field of the Invention

The present invention relates to a lamellar structure of containers, especially a high temperature and microwave resistant lamellar structure of food containers.

2. Description of Related Art

Dinner plates and lunch boxes were previously made from polystyrene, which is cheap but hard to be processed after usage. For example, it is indecomposable for landfill, and generates poisonous gases under combustion. Therefore, polystyrene has been prohibited for the use in food containers.

The present food containers in the market, especially the take-out packages for food and beverage services, can be divided into paper products and wood products. Paper products are easily deformed when they are thin, but thick paper products would increase purchase costs. Wood products can be easily destroyed, and they have better visual effects than paper products. However, when rice is in contact with the wooden surface of the wood product, rice would easily stick on the surface and cause the waste of food. Besides, wood products are too fragile to be manufactured, and their storage is problematic due to the easily dampened and moldy nature. Therefore, some arts have tried to apply a polymer coating on the surface of wooden containers to separate food from the wooden surface, and make the wooden container harder to disintegrate. However, the polymer coating on the wooden container may separate from the wood plate and be torn by tableware after being exposed to moisture or being microwaved, which is requires further improvements.

### SUMMARY OF THE INVENTION

To solve the problem in the known art, the present invention provides a lamellar structure for making food containers, comprising: a fiber layer, which has a first surface and a second surface; a first biodegradable material layer, which adheres to the first surface of the fiber layer; and a second biodegradable material layer, which adheres to the second surface of the fiber layer; wherein the biodegradable material layer is formed by coating a biodegradable material precursor formula, which comprises a biodegradable polymer and a tenacity adjuster, wherein the tenacity adjuster includes a biological molecule, a biodegradable polymer precursor, water or mixtures thereof, and the tenacity adjuster is heat treated.

In some embodiments, the lamellar structure of the present invention further comprises: a first paper layer, which adheres to the first biodegradable material layer; and a second paper layer, which adheres to the second biodegradable material layer.

### BRIEF DESCRIPTION OF THE DRAWINGS

FIG. 1. shows the lamellar structure of the present invention.

FIG. 2. shows another lamellar structure of the present invention.

### DETAILED DESCRIPTION OF THE INVENTION

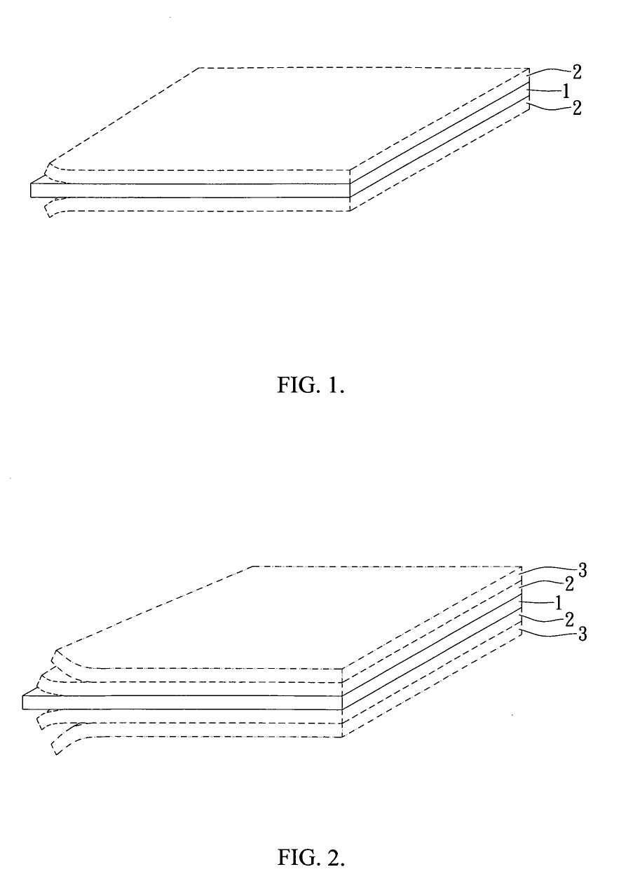

To describe the features and advantages of the present invention more specifically, the lamellar structure for making food containers of the present invention 10 is shown in FIG. 1, comprising: a fiber layer 1, which has a first surface and a second surface; a first biodegradable material layer 2, which adheres to the first surface of the fiber layer; and a second biodegradable material layer 2, which adheres to the second surface of the fiber layer, wherein the biodegradable material layer is formed by coating a biodegradable material precursor formula, which comprises a biodegradable polymer and a tenacity adjuster, wherein the tenacity adjuster includes a biological molecule and a biodegradable polymer precursor, water or mixtures thereof, and the tenacity adjuster is heat treated.

The fiber layer in the present invention is microstructurally composed of fibers, and the material of the fiber layer is biodegradable. Therefore, the obtained food container after usage can be processed by landfill or combustion without any environment hazard. The material suitable for forming the fiber layer of the present invention includes paper fiber, plant fiber or wood fiber.

The biodegradable material layer of the present invention is composed of a composition including a biodegradable polymer and a tenacity adjuster. The use of tenacity adjuster makes the biodegradable polymer more ductile, and the biodegradable polymer can penetrate more deeply into the fiber layer when contacting the fiber layer. Therefore, the layers of the food container will not separate or flake off under heat or microwave. The suitable material for biodegradable polymer of the present invention includes polyglycolic acid, polylactic acid, polycaprolactone, polyhydroxybutyrate, polyhydroxybutyric acid, polyvinyl acetate, polybutylene succinate, polyvinyl alcohol, poly-p-dioxanone or the copolymer thereof.

The tenacity adjuster of the present invention includes a biological molecule and a biodegradable polymer precursor, water or mixtures thereof. The biological molecule includes vegetable gelatin, agar, animal gelatin, chitosan, collagen, hyaluronic acid or mixtures thereof. The biodegradable polymer precursor is not limited to the biodegradable polymer used, i.e. the precursor can be the same as the biodegradable polymer precursor used in the embodiment, or other precursor that forms different biodegradable polymer.

As shown in FIG. 2, in some embodiments, the lamellar structure 20 of the present invention can be combined with a paper layer 3 outside of the biodegradable material layer 2. The adhesion property of the biodegradable material layer 2 of the present invention is better than that of a material layer using biodegradable polymer alone, so combined with either fiber layer 1 or paper layer 3, the biodegradable material layer 2 can penetrate more deeply into fiber layer 1 and paper layer 3 than using biodegradable polymer alone.

The layers of lamellar structure of the present invention can be compressed by the methods in the known art to be flattened and close-packed, such as but not limited to rolling.

The food container made from the lamellar structure of the present invention has excellent high temperature and microwave resistance, and the layers are close-packed to prevent flaking off when rubbing with the tableware. Furthermore, the whole structure is made from biodegradable material, which can decompose through landfill after usage without secondary environmental pollution.

From the above description, one skilled in the art can easily ascertain the essential characteristics of the present invention, and without departing from the spirit and scope thereof, can make various changes and modifications of the invention to adapt it to various usages and conditions. Accordingly, other embodiments are also within the scope of the following claims.

What is claimed is:

1. A lamellar structure for making food containers, comprising:
a fiber layer, which has a first surface and a second surface;
a first biodegradable material layer, which adheres to the first surface of the fiber layer; and
a second biodegradable material layer, which adheres to the second surface of the fiber layer;
wherein the biodegradable material layer is formed by coating a biodegradable material precursor formula, which comprises a biodegradable polymer and a tenacity adjuster, wherein the tenacity adjuster includes a biological molecule and a biodegradable polymer precursor, water or mixtures thereof, and the tenacity adjuster is heat treated.

2. The lamellar structure according to claim 1, wherein the material of the fiber layer is paper fiber.

3. The lamellar structure according to claim 1, wherein the material of the fiber layer is plant fiber.

4. The lamellar structure according to claim 1, wherein the material of the fiber layer is wood fiber.

5. The lamellar structure according to claim 1, wherein the biodegradable polymer includes polyglycolic acid, polylactic acid, polycaprolactone, polyhydroxybutyrate, polyhydroxybutyratic acid, polyvinyl acetate, polybutylene succinate, polyvinyl alcohol, poly-p-dioxanone or copolymers thereof.

6. The lamellar structure according to claim 1, wherein the biological molecule includes vegetable gelatin, agar, animal gelatin, chitosan, collagen, hyaluronic acid or mixtures thereof.

7. The lamellar structure according to claim 1, further comprising:
a first paper layer, which adheres to the first biodegradable material layer; and
a second paper layer, which adheres to the second biodegradable material layer.
